(19) United States
(12) Patent Application Publication
(10) Pub. No.: US 2012/0113564 A1
(43) Pub. Date: May 10, 2012

(54) Lithium ion capacitor and method of fabricating the same

(75) Inventors: Jun Hee Bae, Seoul (KR); Hak Kwan Kim, Seoul (KR); Bae Kyun Kim, Seongnam (KR); Ho Jin Yun, Suwon (KR)

(73) Assignee: SAMSUNG ELECTRO-MECHANICS CO., LTD., Suwon (KR)

(21) Appl. No.: 13/064,296

(22) Filed: Mar. 16, 2011

(30) Foreign Application Priority Data
Nov. 4, 2010 (KR) 10-2010-0109312

(51) Int. Cl. H01G 9/155; H01G 9/04

(52) U.S. Cl. 361/502; 29/25.03

(57) ABSTRACT

There are provided a lithium ion capacitor and a method of fabricating the same. The lithium ion capacitor includes: a first electrode made of a first electrode material including activated carbon, a water-soluble metal oxide, and a water based binder; and a second electrode disposed to be faced to the first electrode, having a separating film therebetween and made of a second electrode material capable of reversibly containing lithium ions. Therefore, the lithium ion capacitor having improved energy density and output density may be provided, and the fabricating method thereof having environmentally-friendly characteristics and a competitive pricing may be provided.

### CROSS-REFERENCE TO RELATED APPLICATIONS

This application claims the priority of Korean Patent Application No. 10-2010-0109312 filed on Nov. 4, 2010, in the Korean Intellectual Property Office, the disclosure of which is incorporated herein by reference.

### BACKGROUND OF THE INVENTION

1. Field of the Invention

The present invention relates to a lithium ion capacitor and a method of fabricating the same, and more particularly, to a lithium ion capacitor having improved capacitance characteristics, being environmentally-friendly, and ensuring a competitive price, and a method of fabricating the same.

2. Description of the Related Art

A supercapacitor, which is a capacitor having very large capacitance, is also called an ultra-capacitor or an ultra high-capacitance capacitor. Super capacitors may be divided into an electric double layer capacitor accumulating electricity through the electrostatic adsorption and desorption of ions, a pseudocapacitor accumulating electricity through an oxidation-reduction reaction, and a hybrid capacitor having an asymmetric electrode.

A battery, which is the most general type of energy storage device, may store a significant amount of energy, while having a relatively small volume and weight, and generate an appropriate output for various purposes, thereby being used for a variety of purposes. However, the battery has poor storage characteristics and life span, regardless of the kind thereof.

This is due to a natural deterioration phenomenon or a deterioration phenomenon according to the use of chemical materials contained within the battery. A supercapacitor, on the other hand, uses a phenomenon of a surface chemical reaction or a simple movement of ions on the interface between an electrode and an electrolyte for the charging thereof, unlike a battery using chemical reaction. Accordingly, the super capacitor has come to prominence as a next generation storage device capable of being used as an auxiliary battery or as a product substituting for a battery, due to desirable characteristics thereof such as rapid charging and discharging, high charging and discharging efficiency and semi-permanent cycle life span.

However, in spite of these advantages, the supercapacitor has a lower capacitance than that of a battery, thereby providing limitations in use thereof. Accordingly, recently, improving the capacitance of the supercapacitor is the most important issue in the supercapacitor.

### SUMMARY OF THE INVENTION

An aspect of the present invention provides a lithium ion capacitor capable of having energy density and output density significantly improved through improvement of capacitance characteristics, being environment-friendly, and ensuring a competitive price, and a method of fabricating the same.

According to an aspect of the present invention, there is provided a lithium ion capacitor, including: a first electrode made of a first electrode material including activated carbon, a water-soluble metal oxide, and a water based binder; and a second electrode disposed to face the first electrode, having a separating film therebetween and made of a second electrode material capable of reversibly containing lithium ions.

The water-soluble metal oxide may be at least one selected from a group consisting of LiFePO₄ and LiTiOₓ(LTO).

The water based binder may be at least one selected from a group consisting of Polytetrafluoro Ethylene (PTFE), Carboxy Methyl Cellulose (CMC) and Styrene Butadien Rubber (SBR).

The second electrode material may be graphite or graphite doped with lithium.

A capacitance of the lithium ion capacitor may be greater by as much as 10 mAh or more at the same voltage as compared to a lithium ion capacitor of which the first electrode is made only of activated carbon.

A thickness of the first electrode may be 10 to 400 μm and a thickness of the second electrode may be 10 to 100 μm.

According to another aspect of the present invention, there is provided a method of fabricating a lithium ion capacitor, the method comprising: forming an first electrode using an first electrode material including activated carbon, a water-soluble metal oxide and a water based binder; and sequentially stacking a separating film and a second electrodes made of a second electrode material capable of reversibly containing lithium ions on the first electrode.

The water-soluble metal oxide may be selected from a group consisting of LiFePO₄ and LiTiOₓ (LTO).

The water based binder may be at least one selected from a group consisting of Polytetrafluoro Ethylene (PTFE), Carboxy Methyl Cellulose (CMC) and Styrene Butadien Rubber (SBR).

The second electrode material may be graphite or graphite doped with lithium.

A capacitance of the lithium ion capacitor may be greater by as much as 10 mAh or more at the same voltage as compared to a lithium ion capacitor of which the first electrode is made only of an activated carbon.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view showing a lithium ion capacitor according to a first exemplary embodiment of the present invention; and

FIG. 2 is a flow chart showing a method of fabricating a lithium ion capacitor according to a first exemplary embodiment of the present invention.

### DETAILED DESCRIPTION OF THE PREFERRED EMBODIMENT

Hereinafter, exemplary embodiments of the present invention will be described in detail with reference to the accompanying drawings, which will fully convey the concept of the invention to those skilled in the art. Moreover, detailed descriptions related to well-known functions or configurations will be ruled out in order not to unnecessarily obscure the subject matter of the present invention.

It is also noted that like reference numerals denote like elements throughout the drawings.

In addition, unless explicitly described to the contrary, the word “comprise” and variations such as “comprises” or “comprising,” will be understood to imply the inclusion of stated elements but not the exclusion of any other elements.

Hereinafter, a method of fabricating a lithium ion capacitor according an exemplary embodiment of the present invention will be described with reference to the accompanying drawings.

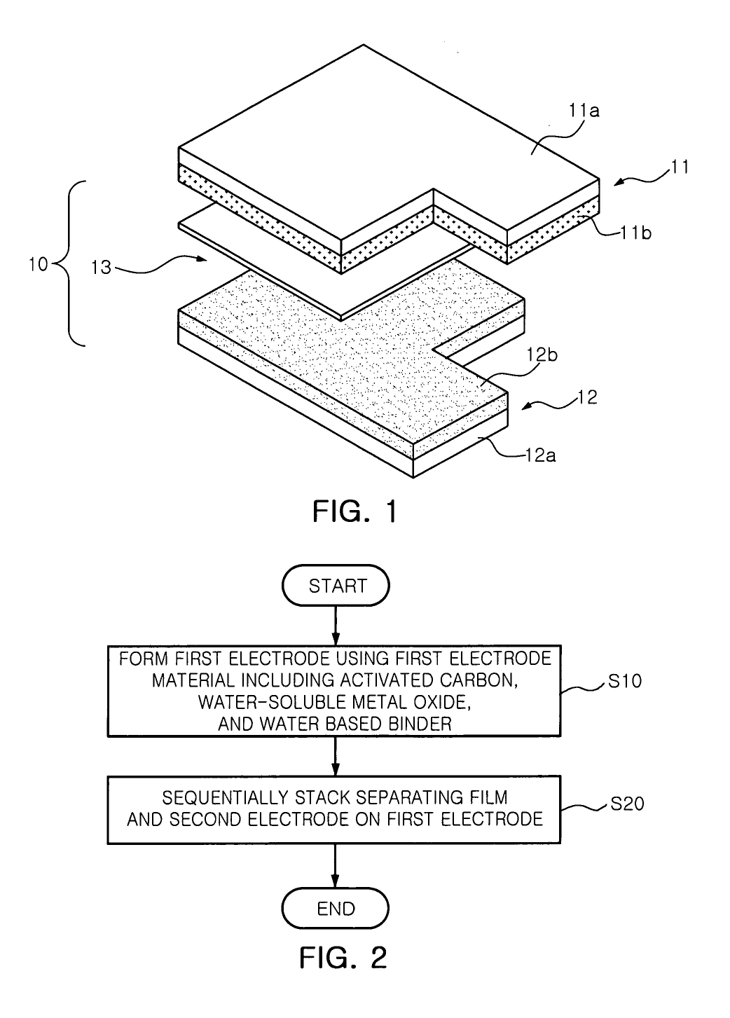

Referring to FIG. 1, a cell, which is the minimum functional unit of a lithium ion capacitor according to a first exemplary embodiment of the present invention, includes a first electrode 11, a second electrode 12, and a separating film 13. The lithium ion capacitor may be formed by stacking or winding several unit cells 10.

Each unit cell 10 according to the first exemplary embodiment of the present invention includes the first electrode 11 and the second electrode 12. Although an exemplary embodiment of the present invention describes a case in which the first electrode 11 and the second electrode 12 are, a positive electrode and a negative electrode, respectively; however, the present invention is not limited thereto. The first electrode 11 may be the negative electrode and the second electrode 12 may be positive electrode.

The first electrode 11 according to the first exemplary embodiment of the present invention may be formed by applying a first electrode material 11b to a conductive sheet 11a. According to the first exemplary embodiment of the present invention, a case in which the first electrode 11 is the positive electrode will be described.

The first electrode 11 may be formed by applying the first electrode material 11b to the conductive sheet 11a or may also be made only of the first electrode material 11b.

The conductive sheet 11a forming the first electrode 11, which serves to transfer an electrical signal to the first electrode material 11b and collect accumulated charges, may be made of metal foil. The conductive sheet 11a may be made of stainless, copper, nickel, titanium, or the like; however the conductive sheet is not limited thereto.

The conductive sheet 11a has a sheet shape; however, may be a mesh-type conductive sheet having a mesh formed on a sheet or may be a foil-type conductive sheet having a foil shape.

As the first electrode material 11b, a material capable of reversibly containing lithium ions may be used. According to the first exemplary embodiment of the present invention, the first electrode material 11b may include an activated carbon, a water-soluble metal oxide, and a water based binder.

As the water-soluble metal oxide, at least one selected from the group consisting of LiFePO₄ and LiTiOₓ (LTO) may be used, without limited thereto.

According to the first exemplary embodiment of the present invention, since the metal oxide is included in the positive electrode, charging potential of the positive electrode is increased. Capacitance characteristics of the lithium ion capacitor may be improved by increasing the charging potential of the entire lithium ion capacitor.

In order to mix the metal oxide with an electrode material according to the related art, an organic binder has been used. However, the activated carbon is a material capable of easily containing the lithium ions; however, it is not mixed with the organic binder, such that it has not been used together with the metal oxide.

However, according to the first exemplary embodiment of the present invention, since the water-soluble metal oxide is used, the water based binder may be used, and since the activated carbon may be easily mixed with the water-soluble material, the metal oxide and the activated carbon may be mixed using the water based binder.

Accordingly, according to the first exemplary embodiment of the present invention, a number of lithium ions may be contained in the lithium ion capacitor because of the use of the activated carbon having excellent adsorptive power, while increasing the charging potential of the positive electrode due to the use of the metal oxide, whereby the output characteristics of the lithium ion capacitor may be improved.

That is, in the case of the present invention, since the water-soluble metal oxide is used, the first electrode material 11b may be formed by mixing the water-soluble metal oxide with the activated carbon using the water based binder. Accordingly, energy density and output density of the lithium ion capacitor are increased, whereby the capacitance characteristics thereof may be improved.

In addition, since the water based binder having environment-friendly characteristics is used, the stability of a fabrication processing is increased.

A thickness of the first electrode material lib is not specifically limited. For example, the thickness of the first electrode material 11b may be set to 10 to 400 μm.

Although the first exemplary embodiment of the present invention describes a case in which the second electrode 12 is the negative electrode, the present invention is not limited thereto. The second electrode 12 may be configured of a conductive sheet 12a and a second electrode material 12b.

The second electrode may be formed by applying the second electrode material to the conductive sheet or may also be made only of the second electrode material.

Similar to the conductive sheet 11a of the first electrode 12, the conductive sheet 12a, which serves to transfer an electrical signal to the second electrode material 12b and collect accumulated charges, may be made of metal foil. The conductive sheet 12a may be made of stainless, copper, nickel, titanium, or the like, and may be a mesh-type conductive sheet or a foil-type conductive sheet, without limited thereto.

As the second electrode material 12b, a material capable of reversibly containing lithium ions may be used. As the second electrode material 12b, a carbon material such as graphite, a hard carbon coke, or the like, a polyacene based material (PAS), and the like, may be used by way of example, without limited thereto.

In addition, the second electrode may be formed by mixing the second material 12b with a conductive material. As the conductive material, acetylene black, graphite, and or like, may be used by way of example, without limited thereto.

When the negative electrode is the second electrode, the second electrode material may be formed with a lithium metal thin film or be doped with the lithium ions. This is to allow the lithium ions to be easily contained within the cells.

According to the first embodiment of the present invention, graphite or graphite doped with the lithium ions may be used as the material 12b of the second electrode, which is the negative electrode. Accordingly, the lithium ions may easily be contained within the cells of the lithium ion capacitor by the lithium thin film formed in the graphite or the lithium ions doped in the graphite.

A thickness of the electrode material 12b formed on the conductive sheet 12a is not specifically limited. For example, the thickness of the electrode material 12b may be set to 10 to 100 μm.

According to the first exemplary embodiment of the present invention, the separating film 13 may be made of a porous material so that ions may be penetrated therethrough. In this case, as the porous material, there are polypropylene, polyethylene glass fiber, and the like by way of example.

According the first exemplary embodiment of the present invention, the material 11b of the first electrode corresponding to the positive electrode is formed by mixing activated carbon, water-soluble metal oxide, and water based binder.

According the first exemplary embodiment of the present invention, the water-soluble metal oxide may improve capacitance characteristics of the lithium ion capacitor and may improve defects caused due to use of a non-water based binder.

According to the first exemplary embodiment of the present invention, as the material of the first electrode, which is the positive electrode, the water-soluble metal oxide capable of supplying the lithium ions to an electrolyte may be used. The water-soluble metal oxide may include lithium to generate and supply the lithium ions.

According to the first exemplary embodiment, as the water-soluble metal oxide, at least one selected from the group consisting of LiFePO₄ and LiTiOₓ (LTO) may be used.

In addition, according to the first exemplary embodiment of the present invention, graphite electrode doped with the lithium ions may be used as the second electrode, which is the negative electrode. Accordingly, the lithium ion capacitor in which both of the first and second electrodes may use the lithium ions, which are a single ion species, in electro-chemical reaction to minimize a reduction phenomenon in ion conductivity of an internal electrolyte of the capacitor during the charging and the discharging thereof, and the metal oxide having high specific capacitance may be used in the first electrode corresponding to the positive electrode to maximize the energy density and the output density, may be provided.

Therefore, in the case of such a lithium ion capacitor, the capacitance characteristics may be improved as compared to the electric double layer capacitor in which both of the positive and negative electrodes are made of the activated carbon.

According to an exemplary embodiment of the present invention, the capacitance of the lithium ion capacitor may be greater by as much as 10 mAh or more at the same voltage, as compared to the lithium ion capacitor made only of the activated carbon.

While the lithium ion capacitor of which the positive electrode is made only of the activated carbon has the capacitance of 20 mAh at 2.0V, the lithium ion capacitor made of the water-soluble metal oxide and the activated carbon according to an exemplary embodiment of the present invention may have 30 mAh at 2.0V.

In addition, while the lithium ion capacitor made only of the activated carbon has the capacitance of 9 mAh at 2.5V, the lithium ion capacitor made of the water-soluble metal oxide and the activated carbon may have 23 mAh at 2.5V.

That is, the lithium ion capacitor including the water-soluble metal oxide and the activated carbon according to an exemplary embodiment of the present invention may have the capacitance greater by as much as 10 mAh or more, as compared to the lithium ion capacitor of which the first electrode is made only of the activated carbon.

In addition, according to an exemplary embodiment of the present invention, since the water-soluble metal oxide is used, the water based binder may be used. When the non-water based binder was used according to the related art, expensive volatile organic compound harmful to the air has been used.

However, according to the first exemplary embodiment of the present invention, at least one selected from the group consisting of Polytetrafluoro Ethylene (PTFE), Carboxy Methyl Cellulose (CMC) and Styrene Butadien Rubber (SBR), which are the water based binders, may be used.

According to the first exemplary embodiment of the present invention, the water binder, which is environment-friendly and a cheap binder, is used, whereby a competitive price of a chip may be secured.

According to the first exemplary embodiment of the present invention, since the water-soluble metal oxide is used as the first electrode material configuring the positive electrode, the water based binder may be used.

Accordingly, since the metal oxide is included in the activated carbon, the electrode materials of the positive and negative electrodes of the lithium ion capacitor use the lithium ions, which are the single ion species, in the electrochemical reaction, whereby a reduction phenomenon in ion conductivity and a depletion phenomenon of ion species within the internal electrolyte of the capacitor during the charging and the discharging thereof may be minimized. Accordingly, the electrode materials of the positive and negative electrodes have high specific capacitance, whereby the energy density and the output density of the lithium ion capacitor may be improved.

Referring to FIG. 2 showing a method fabricating of a lithium ion capacitor according to the first exemplary embodiment of the present invention, a following process is performed in order to fabricate the lithium ion capacitor according to the first exemplary embodiment of the present invention.

The method of fabricating a lithium ion capacitor according to the first exemplary embodiment of the present invention includes forming the first electrode using the first electrode material including the activated carbon, the water-soluble metal oxide and the water based binder (S10) and sequentially stacking the separating film and the second electrode made of the second electrode material capable of reversibly containing the lithium ions on the first electrode (S20).

According to the first exemplary embodiment of the present invention, the first electrode made of the first electrode material, the separating film, and the second electrode made of the second electrode material are sequentially stacked to fabricate the unit cells, and the unit cells are stacked or wound, whereby a multilayered capacitor cell or a wound capacitor cell may be fabricated.

According to an exemplary embodiment of the present invention, the first electrode material may include the water-soluble metal oxide made of at least one selected from the group consisting of LiFePO₄ and LiTiOₓ (LTO). In addition, as the second electrode, which is the negative electrode, the graphite or the graphite doped with the lithium may be used. Accordingly, the electrode materials of the positive and negative electrodes may use the lithium ions, which are the single ion species, in the electrochemical reaction. Therefore, the reduction phenomenon in ion conductivity and the depletion phenomenon of ion species within the internal electrolyte of the capacitor during the charging and the discharging thereof may be minimized, whereby the energy density and the output density of the capacitor may be improved.

Accordingly, the lithium ion capacitor as described above may secure the capacitance greater by as much as 10 mAh or more, as compared to the lithium ion capacitor of which the first electrode, that is, the positive electrode is made only of the activated carbon, which is a significantly improved value than the capacitance of the electric double layer capacitor.

In addition, according to an exemplary embodiment of the present invention, the water-soluble metal oxide may be dispersed using the water based binder. As the water based binder, at least one selected from the group consisting of Polytetrafluoro Ethylene (PTFE), Carboxy Methyl Cellulose (CMC) and Styrene Butadien Rubber (SBR) may be used.

According to the exemplary embodiment of the present invention, since the cheap water based binder is used, the competitive price may be secured without being harmful to the environment.

According to the exemplary embodiment of the present invention, the graphite or the graphite doped with the lithium may be used as the second electrode material.

According to the exemplary embodiment of the present invention, both of the positive and negative electrodes may use the lithium ions, which are the single ion species, in the electro-chemical reaction and have high specific capacitance, whereby the energy density and the output density may be improved.

As set forth, according the exemplary embodiment of the present invention, the lithium ion capacitor having the improved capacitance characteristics to minimize a reduction phenomenon in ion conductivity and a depletion phenomenon of ion species within the internal electrolyte of the capacitor during the charging and the discharging thereof, thereby significantly improving energy density and output density and having the environment-friendly characteristics and competitive price, and the method of fabricating the same may be provided.

While the present invention has been shown and described in connection with the exemplary embodiments, it will be apparent to those skilled in the art that modifications and variations can be made without departing from the spirit and scope of the invention as defined by the appended claims.

What is claimed is:

1. A lithium ion capacitor, comprising:
a first electrode made of a first electrode material including activated carbon, a water-soluble metal oxide, and a water based binder; and
a second electrode disposed to face the first electrode, having a separating film therebetween and made of a second electrode material capable of reversibly containing lithium ions.

2. The lithium ion capacitor of claim 1, wherein the water-soluble metal oxide is at least one selected from a group consisting of LiFePO₄ and LiTiOₓ (LTO).

3. The lithium ion capacitor of claim 1, wherein the water based binder is at least one selected from a group consisting of Polytetrafluoro Ethylene (PTFE), Carboxy Methyl Cellulose (CMC) and Styrene Butadien Rubber (SBR).

4. The lithium ion capacitor of claim 1, wherein the second electrode material is graphite or graphite doped with lithium.

5. The lithium ion capacitor of claim 1, wherein a capacitance of the lithium ion capacitor is greater by as much as 10 mAh or more at the same voltage as compared to a lithium ion capacitor of which the first electrode is made only of activated carbon.

6. The lithium ion capacitor of claim 1, wherein a thickness of the first electrode is 10 to 400 μm and a thickness of the second electrode is 10 to 100 μm.

7. A method of fabricating a lithium ion capacitor, the method comprising:
forming an first electrode using an first electrode material including activated carbon, a water-soluble metal oxide and a water based binder; and
sequentially stacking a separating film and a second electrodes made of a second electrode material capable of reversibly containing lithium ions on the first electrode.

8. The method of claim 7, wherein the water-soluble metal oxide is selected from a group consisting of LiFePO₄ and LiTiOₓ (LTO).

9. The method of claim 7, wherein the water based binder is at least one selected from a group consisting of Polytetrafluoro Ethylene (PTFE), Carboxy Methyl Cellulose (CMC) and Styrene Butadien Rubber (SBR).

10. The method of claim 7, wherein the second electrode material is graphite or graphite doped with lithium.

11. The method of claim 7, wherein the capacitance of the lithium ion capacitor is greater by as much as 10 mAh or more at the same voltage as compared to a lithium ion capacitor of which the first electrode is made only of an activated carbon.
